(19) United States
(12) Patent Application Publication
(10) Pub. No.: US 2003/0151825 A1
(43) Pub. Date: Aug. 14, 2003

(54) Polyacrylate-based light adjustable optical element

(75) Inventors: Christopher W. Bielawski, Pasadena, CA (US); Jagdish M. Jethmalani, San Diego, CA (US); Robert H. Grubbs, South Pasadena, CA (US); Julia A. Kornfield, Pasadena, CA (US)

Correspondence Address: FULBRIGHT & JAWORSKI, LLP, 1301 MCKINNEY, SUITE 5100, HOUSTON, TX, 77010-3095, US

(73) Assignee: CALIFORNIA INSTITUTE OF TECHNOLOGY, Pasadena, CA

(21) Appl. No.: 10/328,485

(22) Filed: Dec. 23, 2002

Related U.S. Application Data
(60) Provisional application No. 60/344,181, filed on Dec. 28, 2001.

(51) Int. Cl. G02B 1/04

(52) U.S. Cl. 359/642; 428/522

(57) ABSTRACT

The invention relates to novel, light adjustable optical elements. The optical elements contain an acrylate-based modifying composition which is capable of stimulus-induced polymerization. Novel telechelic acrylate polymers are also disclosed.

The present application claims the benefit of the priority data in U.S. Application No. 60/344,181, filed Dec. 28, 2001.

### BACKGROUND OF THE INVENTION

The invention relates to optical elements whose optical properties can be adjusted post-fabrication using an acrylate-based modifying composition (“MC”). In one embodiment, an intraocular lens is provided whose optical power can be remotely adjusted.

### BRIEF DESCRIPTION OF THE INVENTION

Approximately two million cataract surgery procedures are performed in the United States annually. The procedure generally involves making an incision in the anterior lens capsule to remove the cataractous crystalline lens and implanting an intraocular lens in its place. The power of the implanted lens is selected (based upon preoperative measurements of ocular length and corneal curvature) to enable the patient to see without additional corrective measures (e.g., spectacles or contact lenses). Unfortunately, due to errors in measurement, and/or variable lens positioning and wound healing, about half of all patients undergoing this procedure will not enjoy optimal vision without correction after surgery. Brandser et al., Acta Ophthalmol Scand 75:162-165; Oshika et al., J Cataract Refract Surg 24:509-514 (1998). Because the power of prior art intraocular lenses generally cannot be adjusted once they have been implanted, the patient typically must choose between replacing the implanted lens with another lens of a different power or be resigned to the use of additional corrective lenses such as spectacles or contact lenses. Since the benefits typically do not outweigh the risks of the former, it is almost never done.

An intraocular lens whose power may be adjusted after implantation and subsequent wound healing would be an ideal solution to post-operative refractive errors associated with cataract surgery. Moreover, such a lens would have wider applications and may be used to correct more typical conditions such as myopia, hyperopia, and astigmatism. Although surgical procedures such as LASIK which uses a laser to reshape the cornea are available, only low to moderate myopia and hyperopia may be readily treated. In contrast, an intraocular lens, which would function just like spectacles or contact lenses to correct for the refractive error of the natural eye, could be implanted in the eye of any patient. Because the power of the implanted lens may be adjusted, post-operative refractive errors due to measurement irregularities and/or variable lens positioning and wound healing may be fine-tuned in situ.

### SUMMARY OF THE INVENTION

The invention relates to optical elements whose optical properties can be modified post-fabrication. The optical elements of the invention have dispersed within the element acrylate-based MCs that are capable of external stimulus-induced polymerization.

The optical properties of the optical element such as refractive index or radius of curvature are adjusted through the polymerization of the MC to form a polymer matrix within at least a portion of the element. This matrix causes changes in the optical properties of the element, specifically the refractive index. The polymerization of the MC can also induce changes in the shape of the optical element. These shape changes can also affect the optical properties of the element.

### DETAILED DESCRIPTION OF THE INVENTION

The optical elements of the present invention are capable of post-fabrication modification of their optical properties without resort to the addition or removal of materials from the element. The change in optical properties is accomplished through the use of an acrylate-based MC dispersed within the optical element. The MC is capable of stimulus-induced polymerization by polymerizing the MC within the optical element if the optical properties of the element can be modified.

The term optical element includes any lens or element which transmits or reflects light, including, but not limited to lenses, mirrors, optical disks (e.g., compact discs), prisms, and data storage disks. The term lenses includes lenses for vision correction including spectacle lenses, contact lenses, intraocular lenses, and the like.

Modification of the optical properties can occur from the formation of a second acrylate-based polymer matrix in the lens or from migration of the MC in the element or both. For example, the formation of the acrylate polymer matrix changes the material characteristics of the optical element, and thus, its refraction capabilities. In general, the formation of the acrylate-based matrix typically increases the refractive index. After the matrix is formed, the unreacted MC will migrate into the region where the matrix has formed over time. If enough time is permitted, the MC will reequilibrate and redistribute throughout the optical element. If the structure of the optical element is flexible, the migration of the MC will cause swelling in the region where polymerization took place. This swelling will cause a change in shape which can also cause a change in optical properties.

In one embodiment, the optical element is formed from a first polymer matrix. The MC is dispersed throughout the first polymer matrix. In the specific embodiment of an intraocular lens, the first polymer matrix and the MC must be biocompatible.

Illustrative examples of a suitable first polymer matrix include: polyacrylates such as polyalkyl acrylates and polyhydroxy alkyl acrylates; polymethacrylates such as polymeth methacrylates (“PMMA”), polyhydroxyethyl methacrylate (“PHEMA”), and polyhydroxypropyl methacrylate (“HPMA”).

The first polymer matrix is a covalently or physically linked structure that functions as an optical element and is formed from a first polymer matrix composition. In general, the first polymer matrix composition comprises one or more monomers that upon polymerization will form the first polymer matrix. The first polymer matrix composition optionally may include any number of formulation auxiliaries that modulate the polymerization reaction or improve any property of the optical element. Illustrative examples of suitable monomers include acrylics, methacrylates, and copolymers thereof. As used herein, a “monomer” refers to any unit (which may itself either be a homopolymer or copolymer) which may be linked together to form a polymer containing repeating units of the same. If the monomer is a copolymer, it may be comprised of the same type of monomers (e.g., two different acrylics) or it may be comprised of different types of monomers (e.g., an acrylic).

In preferred embodiments, the first polymer matrix generally possesses a relatively low glass transition temperature (“T_{g}”) such that the resulting intraocular lens tends to exhibit fluid-like and/or elastomeric behavior. This allows the intraocular lens to be readily foldable facilitating implantation of the lens. In one embodiment, the T should be less than 25° C., more preferably less than 20° C. This insures that the lens can be folded at room temperature. Low glass transition temperatures are also important for other optical elements where flexibility is important, e.g., contact lenses. Higher T_{g}s are desirable where the element should exhibit more rigidity such as data storage disks, spectacle lenses or the like.

The first polymer matrix can be formed from the same macromers in the modifying compounds. In the case of the first polymer matrix, the end groups should be capable of cross-linking. Illustrative examples of suitable cross-linkable groups include, but are not limited to, hydride, acetoxy, alkoxy, amino, anhydrate, aryloxy, carboxy, enoxy, epoxy, halide, isocyano, olefinic and oxime. Although not necessary for the practice of the invention, the mechanism for cross-linking the macromers to form the first polymer matrix is different from the mechanism for the stimulus induced polymerization of the MC. For example, if the MC is polymerized by photoinduced polymerization, then it is preferred that the macromers used to form the first polymer matrix have cross-linkable groups that are polymerized by catalyst-induced polymerization.

In one embodiment, the one or more monomers that form the first polymer matrix are polymerized and cross-linked in the presence of the MC. In another embodiment, polymeric starting material that forms the first polymer matrix is cross-linked in the presence of the MC. Under either scenario, the MC components must be compatible with and not appreciably interfere with the formation of the first polymer matrix. Similarly, the formation of the second polymer matrix should also be compatible with the existing first polymer matrix. Put another way, the first polymer matrix and the second polymer matrix should not phase separate and light transmission by the optical element should be unaffected.

The preferred MC is a multifunctional telechelic polyacrylate having the general formula

$$\begin{matrix}{X — ( A )}_{m} {— Q — ( A )}_{m} {— X}^{1} \\ or \\ {X — ( A )}_{n} {— ( {A}^{1} )}_{m} {— Q — ( A )}_{m} {— ( {A}^{1} )}_{n} {— X}^{1}\end{matrix}$$

wherein Q is an acrylate-based multifunctional initiator useful in Atom Transfer Radical Polymerization (“ATRP”); A and A¹ are the same or different and have the general structure:

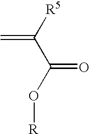

wherein R is selected from the group consisting of alkyls, halogenated alkyls, aryls and halogenated aryls, with phenyl preferred, R⁵ is selected from the group consisting of hydrogen, alkyls, halogenated alkyls, aryls and halogenated aryls, m and n are integers, and X and X¹ are the same or different and contain a moiety capable of stimulus induced polymerization.

In the preferred embodiment, Q is an initiator capable of inducing ATRP polymerization of acrylic-based monomers. This class of initiator includes dihaloacrylates with methyl dichloroacrylate most preferred.

X and X¹ contain photopolymerizable groups including acrylate, allyloxy, cinnamoyl, methacrylate, stibenyl, and vinyl with acrylate and methacrylate preferred.

The preferred MC of the invention is a block or random co-polymer with the general formula:

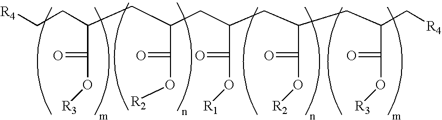

wherein R¹ is a C1 to C10 alkyl, R₂ and R₃ are independently selected from the group comprising alkyl, phenyl, alkylphenyl, halogenated phenyl, halogen substituted alkylphenyl and R4 is a group capable of photopolymerization and m and n are integers.

The preferred method for producing the MC useful in practice of this invention is ATRP which involves controlled free radical polymerization of monomers to produce polymers or macromers having a narrow polydispersity index (PDI”) (e.g., ≦2.0) at fairly high yields. ATRP is a metal mediated halogen exchange process which ensures all polymer chains grow at the same rate giving excellent control over the polymerization. This, in turn, allows for good control over the PDI. It also allows the incorporation of a wide range of monomers.

ATRP uses initiators, such as Q defined above, with transition metal catalysts. In practice of the present invention, the initiator should include two or more halides so as to promote chain growth in two or more directions. Haloalkyls are most preferred with methyldichloroacrylate most preferred.

Transition metals useful in ATRP include copper, iron, nickel, molybdenum, chromium, palladium, ruthenium, and rhodium halide complexes with copper chloride preferred. Cocatalysts such as amines, phosphines and imidazoles are also used.

Use of ATRP to produce the macromers of the invention permits the creation of copolymers with specific levels of comonomer present in the copolymer. For example, it has been found that the presence of halogenated alkyl or phenyl groups in the macromer can affect the optical and physical properties of the final optical element. For example, the use of 4-chlorophenyl ethyl acrylate as one of the monomers can increase the diopter of the final element. Conversely, the use of certain haloalkyls can decrease the diopter. By using ATRP, inclusion of these groups into the macromer can be controlled so as to insure the desired amount of monomers is present in the final optical element. Thus, use of ATRP to make the macromers affords the opportunity to specifically design or modify the optical elements of the invention.

Use of ATRP also allows for careful control of the molecular weight of the macromers. By careful control of monomer consumption, molecular weights of from 1,000 to greater than 20,000 are achieved. As noted above, PDIs are generally ≦2.0 with less than 1.5 preferred.

The ability to control the molecular weights allows ATRP to be used to produce both the MC of the present invention and the first polymer matrix composition. The key is that for the MC, molecular weights should range from about 1000 to about 4500, preferably 1000 to 2000, while the polymers useful in the first polymer matrix composition should have Mn in the range of about 17,000 or greater. In addition, the MC and the polymers for the first polymer matrix composition should have different functional end groups with the MC having endgroups containing photopolymerizable moieties and the polymers for the FPMC having endgroups capable of polymerization by means other than photopolymerization, e.g., catalyst induced polymerization.

The addition of functional groups is accomplished using well known techniques. For example, the addition of a halogenated alkyl methacrylate such as ethyl-α-bromo methacrylate results in the addition of a methacrylate end functionalized polymer. The terminal methacrylate group serves as the desired functional moiety.

Similarly, addition of alkyl alcohol results in a hydroxy-end terminated polymer. These polymers can, in turn, be used by themselves or by the substitution in addition to other functional groups, such as cross-linkable groups, including but not limited to acetoxy, amino, alkoxy, halide and mercapto. Photopolymerizable groups, such as acrylate, methacrylate, stibenyl, cinnamoyl allyloxy and vinyls groups, may also be added. Polymers with cross-linkable groups are useful in preparing the FMCP described above; while macromers suitable for use as MC will have photopolymerizable groups.

For example, in one embodiment, FMCP is found using hydroxy end terminated telechelic polyacrylates as well as photoinitiators, photoabsorbers and the like. This results in a FMCP with methacrylate contains macromers dispersed throughout the FMCP. When portions of the FMCP are exposed to a suitable light source, polyrization of the methacrylate contains macromers and subsequent mirgration of unreacted macromer induces changes in optical properties in the FMCP. This change occurs because of changes in the refracture index of the FMCP, changes in shape or both.

A key advantage of the lens of the present invention is that the optical properties of the lenses can be modified post-fabrication, and in the case of an IOL, post-implantation within the eye. For example, in the case of an IOL, any errors in the power calculation due to imperfect corneal measurements and/or variable lens positioning and wound healing may be modified in a post-surgical outpatient procedure.

In addition to the change in the lens refractive index, the stimulus-induced formation of the second polymer matrix and subsequent migration of the MC have been found to affect the lens power by altering the lens curvature in a predictable manner. As a result, both mechanisms may be exploited to modulate a lens property, such as power, post-manufacture and, for an IOL, after it has been implanted within the eye. In general, the method for implementing an inventive lens having a first polymer matrix and a MC dispersed therein, comprises:

(a) exposing at least a portion of the lens to a stimulus whereby the stimulus induces the polymerization of the MC.

If after modification, the lens property does not need to be modified, then the exposed portion is the entire lens. The exposure of the entire lens will lock in the then-existing properties of the implanted lens.

However, if a lens characteristic such as its power needs to be modified, then only a portion of the lens (something less than the entire lens) would be exposed. In one embodiment, the method of implementing the inventive optical element further comprises:

(b) waiting an interval of time; and

(c) re-exposing the portion of the element to the stimulus.

This procedure generally will induce the further polymerization of the MC within the exposed lens portion. Steps (b) and (c) may be repeated any number of times until the optical element has reached the desired lens characteristic. At this point, the method may further include the step of exposing the entire lens to the stimulus to lock in the desired lens property.

In another embodiment wherein a lens property needs to be modified, a method for implementing an inventive optical element comprises:

(a) exposing a first portion of the optical element to a stimulus whereby the stimulus induces the polymerization of the MC; and

(b) exposing a second portion of the optical element to the stimulus.

The first element portion and the second element portion represent different regions of the lens although they may overlap. Optionally, the method may include an interval of time between the exposures of the first element portion and the second element portion. In addition, the method may further comprise re-exposing the first element portion and/or the second element portion any number of times (with or without an interval of time between exposures) or may further comprise exposing additional portions of the element (e.g., a third element portion, a fourth element portion, etc.). Once the desired property has been reached, then the method may further include the step of exposing the entire element to the stimulus to lock-in the desired element property.

In general, the location of the one or more exposed portions will vary depending on the type of refractive error being corrected. For example, in one embodiment, the exposed portion of the IOL is the optical zone which is the center region of the lens (e.g., between about 4 mm and about 5 mm in diameter). Alternatively, the one or more exposed lens portions may be along IOL's outer rim or along a particular meridian. In preferred embodiments, the stimulus is light. In more preferred embodiments, the light is from a laser source.

In summary, the present invention relates to a novel optical element that comprises (i) a first polymer matrix and (ii) a MC that is capable of stimulus-induced polymerization dispersed therein. When at least a portion of the optical element is exposed to an appropriate stimulus, the MC forms a second polymer matrix. The amount and location of the second polymer matrix modifies a property such as the power of the optical element by changing its refractive index and/or by altering its shape.

The following examples are offered by way of example and are not intended to limit the scope of the invention in any manner.

### EXAMPLE 1

General procedure for preparing hydroxy end-terminated telechelic polyacrylates (1, Eq. 1):

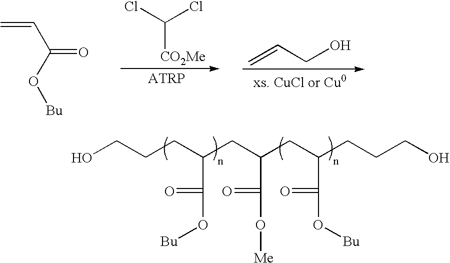

Hydrox and terminated telechelic polyacrylates were prepared using the following procedure. A 25 mL round-bottomed flask was charged with 5.0 mL (56 mmol) of butyl acrylate, 0.3 g (3.0 mmol) of CuCl, 1.0 g (6.5 mmol) of 2,2′-bipyridine, 0.1 mL of 1,3,5-trimethylbenzene (as an internal standard), 0.35 mL (3.4 mmol) methyl dichloroacetate (as the initiator), and a stir bar. The flask was then sealed and heated to 75° C. A lower reaction temperature (40 C.) and lower catalyst loadings were employed when tris[2-(dimethylamino)ethyl]amine (Me₆TREN) (70 mg. 0.3 mmol; CuCl: 30 mg, 0.31 mmol) was used in lieu of 2,2′-bipyridine. Monomer consumption was monitored over time using gas chromatography and compared to the internal standard. After 85-95% of the monomer was consumed, allyl alcohol (2 mL, 30 mmol) and either CuCl (9.5 g, 96 mmol) or Cu⁰ (6.3 g, 100 mmol) were added. After 6 h at 50° C., the reaction vessel was cooled to ambient temperature. The polymer was dissolved in CH₂Cl₂ or diethyl ether (˜250 mL) and extracted with a saturated disodium ethylenediaminetetraacetate (EDTA) solution (4×50 mL) to remove the residual copper salts. The solvent was then partially evaporated and the resultant concentrated polymer solution was poured into excess water causing polymer to precipitate. The polymer was then collected, dried, and characterized by ¹H and ¹³C NMR spectroscopy and size-exclusion chromatography (SEC). Yield: 3.9 g (87%). The molecular weight (Mₙ) was found to be 2400 (relative to polystyrene standards) with a PDI of 1.4. A higher molecular weight analog (Mₙ₌10300, PDI=1.3, relative to polystyrene standards) was prepared using a similar procedure (56 mmol of butyl acrylate, 0.5 mmol of CuCl, 1.1 mmol of 2,2′-bipyridine, and 0.5 mmol of methyl dichloroacetate). In either case, the average number of hydroxy groups per polymer chain (i.e., the average degree of functionality, Fₙ) was found to be near 2.0, as desired.

### EXAMPLE 2

General procedure for preparing methacrylate end-terminated telechelic polyacrylates (2, Eq. 2):

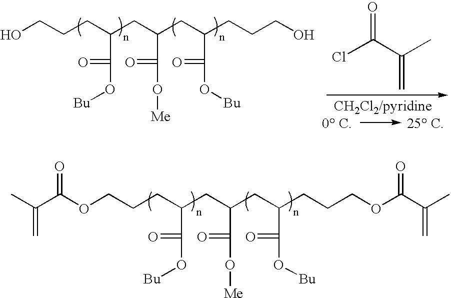

Methacrylate end-terminated telechelic polyacrylates were prepared as follows: A 25 mL round-bottomed flash was charged with 2 g of hydroxy end-terminated telechelic poly(butyl acrylate) (1) (Mₙ₌2400, hydroxy equivalent=1.7 mmol), pyridine (0.75 mL, 9.3 mmol), CH₂Cl₂ (7 mL) and a stir bar. The flask was sealed under Ar and cooled to 0 ° C. using an ice bath. Using a syringe, methacryloyl chloride (0.45 mL, 4.6 mmol) was then added dropwise. After the addition was complete, the reaction was allowed to proceed to 0 ° C. for 30 minutes. The ice bath was then removed and the vessel was permitted to warm to ambient temperature. After 6 h, the solution was extracted with water (3×25 mL) and a dilute (0.1 N) aqueous HCl solution (3×25 mL). The solution was concentrated under vacuum and the polymer was purified using flash chromatography (5:1 hexanes/ethyl acetate as eluent, silica gel as the stationary phase). The polymer was characterized by ¹H and ¹³C NMR spectroscopy and SEC (Mₙ₌2500, relative to polystyrene standards). Yield: 1.7 g (81%).

### EXAMPLE 3

General procedure for cross-linking the methacrylate end-terminated telechelic polyacrylates (2) (Eq. 3):

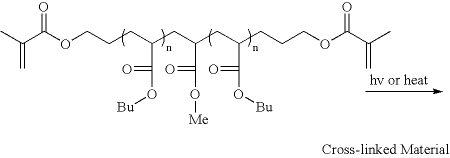

Methacrylate end-terminated telechelic polyacrylate were crosslinked using the following procedure. In a 10 mL glass vial, polyacrylate (1 g) was dissolved in toluene (1 mL) with either benzoyl peroxide or 2,2-dimethoxy-2-phenylacetophenone (5 mg).

This solution was then either heated in an oil bath at 90° C. (benzoyl peroxide-initiated) or phyotlyzed using a 450 watt medium pressure mercury Hanovia lamp (benzoyl peroxide- or 2,2-dimethoxy-2-phenylacetophenone-initiated). An insoluble, tacky material was formed within 15 min under these conditions and was insoluble in common organic solvents. The resulting material was characterized by IR spectroscopy, DSC, and TGA.

What we claim is:

1. An optical element comprising:
i) a first polymer matrix;
ii) an acrylate-based modifying composition capable of stimulus-induced polymerization wherein said stimulus causes the desired modifications of the element and said changes are produced without subsequent removal of said modifying composition.

2. The optical element of claim 1 wherein said modifying composition has the general structure 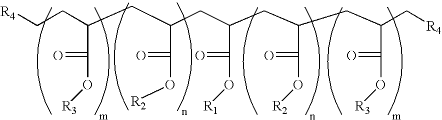
wherein R₁ is a C₁ to C₁₀ alkyl, R₂ and R₃ are independently selected from the group comprising alkyl, phenyl, alkylphenyl, halogenated phenyl, halogenated alkylphenyl and R₄ is a group capable of stimulus induced polymerization and M and N or intergers.

3. The optical element of claim 1.

4. The optical element of claim 1 wherein R₂ and R₃ are both alklys.

5. The optical element of claim 1 where R₄ is a group capable of photopolymerization.

6. The optical element of claim 1 further comprising a photoinitiator.

7. The optical element of claim 1 where R₄ contains an acrylate or methacrylate moiety.

8. The optical element of claim 1 wherein the modifying composition has a molecular weight of from 1000 to 4500.

9. An optical element comprising:
i) A first polymer matrix;
ii) A modifying composition capable of stimulus induced polymerization said modifying composition being the general formula:
$$\begin{matrix}{X — ( A )}_{m} {— Q — ( A )}_{m} {— X}^{1} \\ or \\ {X — ( A )}_{n} {— ( {A}^{1} )}_{m} {— Q — ( A )}_{m} {— ( {A}^{1} )}_{n} {— X}^{1}\end{matrix}$$
where Q is an acrylate-based multifunctional initiator useful in Atom Transfer Radical polymerization; A and A¹ are the same or different and have the general structure 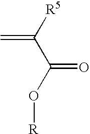
wherein R is selected from the group consisting of alkyls, halogenerated, alkyls, aryls and halogenerated aryls and R⁵ is selected from the group consisting of hydrogen, alkyls, aryls, halogenerated aryls, M and N are intergers and X and X¹ are the same or different and contains a moiety capable of stimulus induced polymerization.

10. The optical element of claim 9 wherein Q is a dehalo acrylate.

11. The optical element of claim 10 wherein Q is methyldichloro acrylate.

12. The optical element of claim 9 wherein X and X¹ contains a photopolymerizable moiety selected from the group consisting of acrylate, allyloxy, cinnamoyl, methacrylate, stibenyl, and vinyl moieties.
